(19) United States
(12) Patent Application Publication
(10) Pub. No.: US 2008/0314984 A1
(43) Pub. Date: Dec. 25, 2008

(54) Magnetic Tag and Method and System for Reading a Magnetic Tag

(75) Inventors: Antonenco Alexandru, Calgary (CA); Arieh Geller, Kiriat Ono (IL); Evgeni Sorkine, Tel Aviv (IL)

Correspondence Address: BROWDY AND NEIMARK, P.L.L.C.;624 NINTH STREET, NW, SUITE 300, WASHINGTON, DC, 20001-5303, US

(73) Assignee: A.C.S. Advanced Coding Systems Ltd., Even Yehuda (IL)

(21) Appl. No.: 11/658,588

(22) PCT Filed: Jul. 20, 2005
(86) PCT No.: PCT/IL2005/000770

§ 371 Date: Jan. 26, 2007

(30) Foreign Application Priority Data
Jul. 26, 2004 (GB) 0416603.9

(51) Int. Cl. G06K 7/08

(52) U.S. Cl. 235/449

(57) ABSTRACT

A method and system are presented for reading a magnetic tag (10), which is formed by an array of elongated magnetic elements arranged in a spaced-apart parallel relationship in accordance with a pattern of coded information. The tag (10) is located within an interrogating zone where an interrogating field is created. The interrogating field has an alternating traveling magnetic field (102) component with a space phase shift distribution along an axis perpendicular to a direction of force lines of the alternating traveling magnetic field component (102).

### FIELD OF THE INVENTION

This invention is generally in the field of security techniques, and relates to a security system and method for reading a magnetic tag, as well as a magnetic tag configuration.

### BACKGROUND OF THE INVENTION

Documents or other valuable items are usually protected from tampering, falsification and unauthorized use. The accepted way of protection consists of introducing one or more security means into, or attaching these means to, a document or an item. The documents and items to be protected include ID cards, passports, licenses, security passes, currency, checks, travel tickets, keys and key cards, and the like. The most widely used encoded security means are optical tags (barcodes) and magnetic markers. Such encoded security means may be either visible or hidden from view.

Conventional optical barcodes suffer from the fact that dust or dirt incidentally appearing on either a data recording medium or a data reader device may cause read errors. As for magnetic markers utilizing magnetic strips, they suffer from that recorded data may be damaged by the influence of an ambient magnetic field or an elevated temperature.

U.S. Pat. No. 6,622,913, assigned to the assignee of the present application, discloses a method and system for reading a code pattern formed by a plurality of spaced-apart magnetic elements, when the code pattern is displaced in a reading direction with respect to a reading head. The reading head comprises a magnetic material producing a high-gradient static magnetic field, and a sensing element of a kind responsive to signals produced by the magnetic elements. The magnetic material is designed such that it defines an extended narrow region where the static magnetic field vector is substantially equal to zero. The sensing element is located substantially within the zero-field region, and is thereby responsive to signals generated by each of the magnetic elements, when the magnetic element is located in the zero-field region.

U.S. Pat. No. 6,556,139 discloses a magnetic microwire for use in a magnetic tag attachable to a product to enable authentication of the product, and a detector device and system for product authentication. The magnetic microwire is a glass-coated amorphous magnetic microwire characterized by a large Barkhausen discontinuity and substantially zero or positive magnetostriction. The microwire is responsive to an external alternating magnetic field generated by the detector device to produce short pulses of magnetic field perturbations.

### SUMMARY OF THE INVENTION

There is a need in the art to facilitate encoding of various items by providing a novel method and system for reading a code formed by one or more elongated magnetic elements.

The main idea of the present invention consists of reading a multiple-element tag by simultaneous interrogation of all the elements in the tag, without the need for scanning, i.e., without the need for a relative displacement between the reading system and the tag. This is achieved by subjecting the tag to an interrogating magnetic field having an AC traveling magnetic field component, which has a space phase shift distribution along an axis perpendicular to a direction of force lines of the AC traveling magnetic field. By this, a time shift is provided between waveforms of the magnetic field component which is proportional to distances between the magnetic elements, and accordingly a pattern formed by response signals of all the magnetic elements to this magnetic field component repeats the pattern of the magnetic elements and allows for retrieving the information in the tag.

There is thus provided according to one broad aspect of the invention, a method of reading a magnetic tag, which is formed by an array of elongated magnetic elements arranged in a spaced-apart parallel relationship in accordance with a pattern of coded information, the method comprising applying to the tag an interrogating field, which has an alternating traveling magnetic field component with a space phase shift distribution along an axis perpendicular to a direction of force lines of the alternating traveling magnetic field component.

The AC traveling magnetic field is preferably applied to the tag such that the force lines of this field are directed substantially along the longitudinal axis of the elongated magnetic element.

Preferably, the interrogating magnetic field includes a low-frequency (e.g., DC) gradient magnetic field component. The field gradient is directed along the force lines of the AC traveling field component.

A value of the magnetic field gradient is preferably selected to satisfy a certain condition to compensate for an angular orientation of the longitudinal axes of the magnetic elements with respect to the force lines of said AC traveling magnetic field component. The value of the magnetic field gradient satisfying the compensation condition is such that, for each point of the magnetic element, the biasing gradient field component effects a shift of the response of said magnetic element to the AC traveling field component which is equal and opposite in direction to a shift of the magnetic element response caused by the phase distribution of the AC traveling magnetic field component. Generally, the value of a biasing gradient is proportional to the angle of tag inclination.

The above may be achieved by sweeping the magnetic field gradient within a certain range of values to thereby obtain the value satisfying the compensation condition.

The AC traveling magnetic field component may be produced by at least two coils operable to provide a phase shift between electric currents trough the coils.

The AC traveling magnetic field component and the biasing gradient magnetic field component may be produced by appropriately operating electric currents through at least two coil pairs. In this case, the electric current through each coil has an AC component that creates the space phase shifted distribution of the magnetic field created by this coil, and a biasing component that creates the magnetic field gradient.

According to another broad aspect of the present invention, there is provided a system for use in reading a magnetic tag formed by at least one elongated magnetic element, the system comprising:
a magnetic field source assembly configured and operable to produce an interrogating field, which has an alternating traveling magnetic field component with a space phase shift distribution along an axis perpendicular to a direction of force lines of the alternating traveling magnetic field;
a receiving unit for receiving a response signal pattern coming from the tag and generating data indicative thereof, thereby allowing for retrieving coded information in the tag.

According to yet another aspect of the present invention, there is provided a magnetic tag carrying coded information, the tag comprising an array of magnetic elements arranged in a spaced-apart parallel relationship being substantially equally spaced from one another, one or more of said magnetic elements, selected in accordance with the coded information, being defected so as to be undetectable by a tag reading system, the defected magnetic element being thereby recognizable by the tag reading system as a free space between non-defected magnetic elements.

According to yet another aspect of the present invention, there is provided a method for manufacturing a magnetic tag carrying coded information, the method comprising: (i) arranging multiple magnetic elements in a spaced-apart parallel relationship with substantially equal spaces between them, and (i) defecting one or more of said magnetic elements, selected in accordance with the coded information, so as to make the selected magnetic elements undetectable by a tag reading system, the defected magnetic element being thereby presenting, for a tag reading process, a free space between non-defected magnetic elements.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1A is a schematic illustration of the principles of the present invention for reading information stored in a magnetic tag;

FIG. 1B shows waveforms of an AC traveling magnetic field acting along the lengths of three different elongated magnetic elements of the tag;

FIG. 2 exemplifies a response signal pattern of the magnetic tag obtained with the present invention;

FIGS. 3A to 3D schematically illustrate the principles of the magnetic tag reading according to another embodiment of the invention;

FIG. 4 schematically illustrates a tag reading system of the present invention;

FIG. 5 exemplifies a magnetic field source assembly suitable to be used in the system of FIG. 4 for generating an AC traveling magnetic field;

FIG. 6 exemplifies a configuration of the tag reading system of the present invention;

FIG. 7 exemplifies an electrical scheme of the system of the present invention; and

FIGS. 8A to 8C schematically illustrate the main principles of another aspect of the invention, consisting of manufacturing a magnetic tag configured to carry certain coded information embedded in the tag.

### DETAILED DESCRIPTION OF THE INVENTION

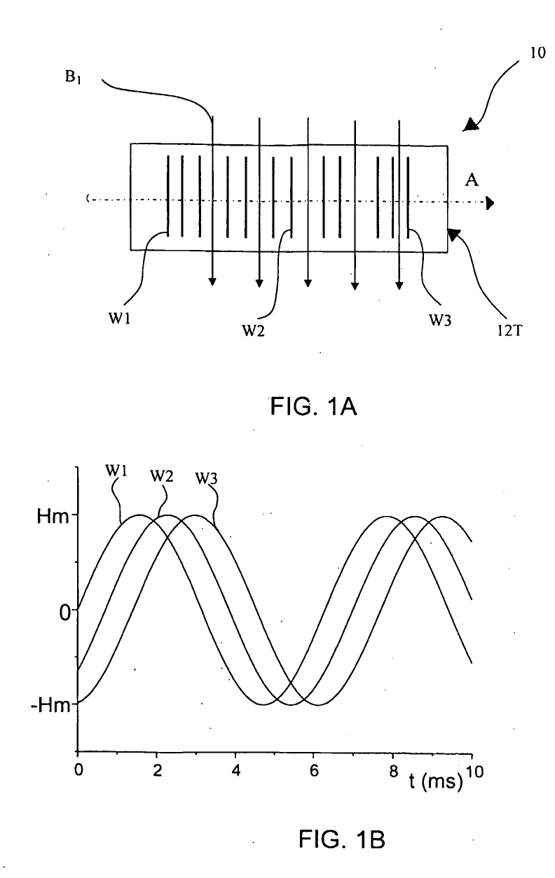

The present invention provides for a system and method for reading a magnetic tag (marker) including one or more elongated magnetic elements. FIG. 1A schematically illustrates the principles of one embodiment of the present invention for reading information stored in a magnetic tag, generally designated 10.

In the present example, the tag 10 includes an array of magnetic elements (wires) W, arranged in a spaced-apart parallel relationship on a substrate 12. It should be understood that the substrate 12 may constitute a label attachable to an item with which the tag is associated, or may constitute the item itself, i.e., the magnetic elements being carried directly by the item. Thus, the term “tag” used herein signifies a pattern formed by elongated magnetic elements W. The magnetic elements (wires) W are arranged in the spaced-apart parallel relationship along an axis A, being typically unequally spaced from one another forming together a predetermined pattern (coded information). The pattern formed by the arrangement of wires presents an identification code (secured information) embedded in the tag.

The magnetic element is configured to be responsive to an external interrogating magnetic field. Typically, the response of such an element is detected as its effect on a magnetic field created by a reading coil arrangement.

The magnetic element may be an amorphous ferromagnetic element, designed like as a strip or wire. Preferably, the magnetic element is a glass-coated amorphous microwire, for example such as disclosed in the above-indicated U.S. Pat. No. 6,622,913, as well as U.S. Pat. Nos. 6,441,737; 6,556,139; and 6,747,559, all assigned to the assignee of the present application. Such a glass-coated microwire is composed of a metal core and a glass coat. Generally, such a glass-coated microwire can be produced with a very small diameter ranging from 1-2 micrometers to tens of micrometers, from a variety of magnetic and non-magnetic alloys and pure metals. Preferably, the magnetic core of the microwire is prepared with an amorphous metal structure, and thus the glass-coated microwire has good mechanical strength, flexibility, and corrosion resistance, so that it can be easily incorporated in paper, plastic, fabrics and other substrate materials. An amorphous magnetic glass-coated microwire is characterized by a unique response to an interrogating magnetic field, and significantly faster re-magnetization as compared to the conventional magnetic elements (e.g., magnetic strips). The glass-coated microwire properties can be controlled by varying the alloy composition and the glass-to-metal diameter ratio. Preferably, microwires that are cast from alloys with zero or positive magnetostriction and characterized by a large Barkhausen discontinuity (Co-based or Fe-based alloys) are used in the tag.

As shown in FIG. 1A, reading a code embedded in the tag (i.e., a code represented by the wires' pattern) is achieved by subjecting the tag 10 to an external interrogating magnetic field. According to the present invention, this magnetic field is the so-called “traveling” magnetic field, namely, has an alternating field component (AC field) with a space phase shift distribution along an axis perpendicular to that of the force lines B₁ of the field, which in the present example in the axis A of wires arrangement. The magnetic traveling field is applied to the tag 10 such that the force lines B₁ of this field extend substantially along the longitudinal axis of the elongated magnetic element (wire) W, and the magnetic field has the space phase shift distribution along the axis A along which the wires W are arranged. When the tag 10 (i.e., the entire pattern formed by wires W) is located in the magnetic field region (an interrogating zone), the wires W respond to this magnetic field at different time moments, respectively, according to the phase shift of the field in particular wire position. Hence, the magnetic field actually acts onto the array of wires as a traveling field, i.e., the magnetic field value varies with both the coordinate and time.

FIG. 1B shows waveforms Hₘ of the traveling magnetic field acting along three different wires W₁, W₂ and W₃. The magnetic field may be of any suitable operating range, the maximal value of magnetic field being limited solely by the capability of power supply and current drivers. As shown, the wires W₁, W₂ and W₃ are sequentially excited by the interrogating magnetic field, i.e., the exciting field value (which depends on the coercivity of the magnetic material of the wires) sequentially “reaches” the successive wires of the tag. As a result, the wires are successively excited by the interrogating field.

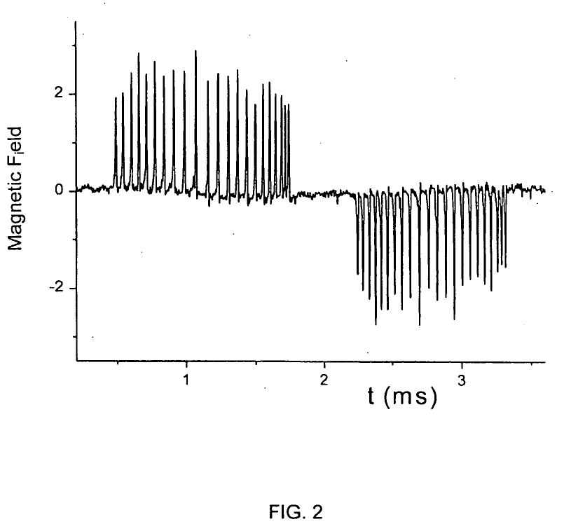

The entire pattern formed by response signals of the wires (obtained with a receiving system which will be described further below) will repeat the pattern of wires of the tag, and may thus be used to retrieve the secured information. A typical signal (tag response pattern) received from the magnetic tag with the method of the invention is shown in FIG. 2. The multiple wires, while being simultaneously subjected to the interrogating magnetic field, successively respond to this field.

The present invention thus allows for reading a magnetic tag without a need for mechanical scanning, i.e., without a need for a relative displacement between a magnetic field source and the tag being read. This is implemented by subjecting the tag to the AC traveling magnetic field such that the field has a phase variable along the axis perpendicular to the direction of the force lines B₁ of the magnetic field. When the force lines B₁ of the magnetic field are directed substantially along the longitudinal axes of the wires W, and is thus phase shifted along the axis A of the magnetic wires arrangement, the wires response pattern can be easily identified and the secured information can be retrieved.

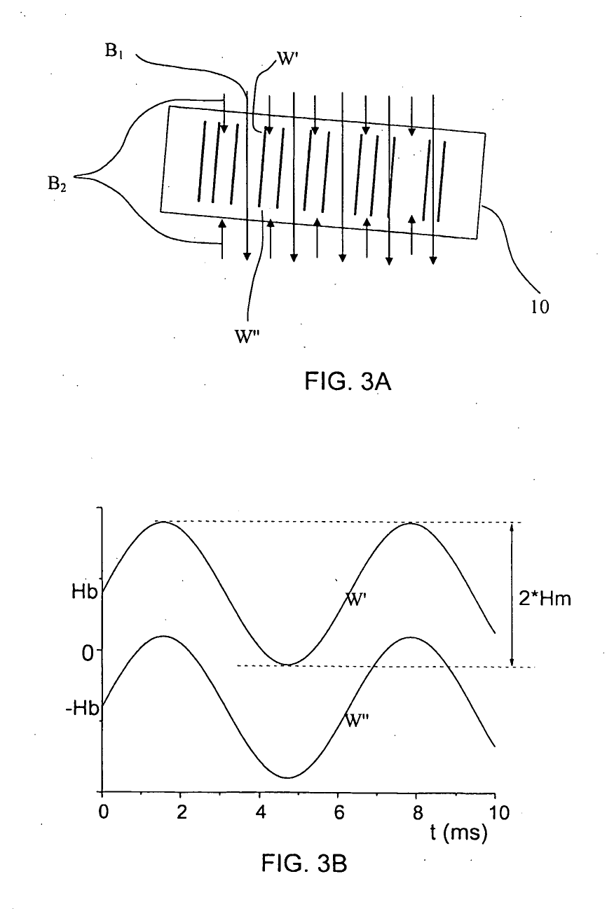

Referring now to FIGS. 3A-3D, there are schematically illustrated the principles of magnetic tag reading according to another embodiment of the invention. According to this embodiment, a magnetic tag 10 (i.e., an array of elongated magnetic elements W) is subjected to a magnetic field having an interrogating AC traveling field component (force lines B₁) and is also subjected to a gradient bias magnetic field component (force lines B₂). The biasing field is an AC field of a relatively low frequency as compared to the AC traveling field. For example, the traveling field frequency is about 300 Hz and the biasing field frequency is about 40 Hz. The force lines B₂ of the biasing field are directed along that of the force lines B₁ of the AC traveling field, with the biasing field gradient being directed along the force lines B₁.

The provision of the gradient biasing magnetic field component is associated with the following. Using only the interrogating AC traveling field component actually requires the magnetic elements of the tag to be strictly aligned with the force lines B₁ of this field, since the angle variation of the tag (e.g., about 1-2 degree tilt between the wire's axis and the force lines B₁ of the AC traveling magnetic field) deteriorates the response signal, which is thus blurred. This problem can be overcome by applying to the tag both the interrogating AC traveling magnetic field component and the gradient bias magnetic field component. Generally, a value of the magnetic field gradient that affects the wire response depends on an angle between the wire and the force lines of the AC traveling magnetic field. In the case when the angular orientation of the tag is unknown, which is practically the case, a value of the biasing field gradient is swept within a certain range of values. Generally, a ratio between the amplitudes of traveling and biasing fields depends on many factors. For example, the amplitude of traveling field is about three times higher than the amplitude of biasing field.

FIG. 3A shows the tag 10 oriented at a certain angle α relative to the force lines B₁ of the interrogating AC traveling field component. The biasing magnetic field component is created inside the interrogating zone (the magnetic field region of AC traveling field) with the force lines B₂ and the field gradient along the force lines B₁ of the interrogating AC traveling field.

To facilitate the explanation, let us assume a DC magnetic field gradient. As indicated above, the value of the biasing field gradient that affects the wire response depends on the angle between the wires and the force lines of the interrogating magnetic field B₁. In a real system, a sweeping magnetic gradient is applied such as to cover a range of possible angles between the magnetic element and the force lines of the interrogating field. When the tag is inclined with respect to the force lines of the AC traveling field B₁, two parts W′ and W″ of the magnetic element W are oriented at opposite angles with respect to the force lines B₁. As a result, these two parts W′ and W″ of the magnetic element W are differently affected by the biasing field.

FIG. 3B shows two waveforms of the gradient biasing field at two different coordinates located within parts W′ and W″, respectively, of the same magnetic element W. Accordingly, the magnetic fields, H_{W}, and H_{W″}, applied to, respectively, the wire parts W′ and W″ are as follows:

H_{W′}=Hₘ·Sin(wt)+H_{b}

H_{W″}=Hₘ·Sin(wt)−H_{b}

wherein Hₘ is the amplitude of the AC traveling field, w is the frequency of this field, t is the time, and H_{b} is the amplitude of the biasing field.

The application of the biasing field provides for compensating for the possible wires inclination with respect to the force lines of the interrogating traveling field. The general principle of this aspect of the invention may be easily understood from the following consideration for the wire response of positive polarity. While a magnetic wire is strictly aligned with the force lines B₁ of the interrogating traveling magnetic field, all points of the wire simultaneously undergo a magnetization process, and the wire response represents a single sharp pulse. When a magnetic wire is inclined relative to the force lines B₁ of the interrogating field, the situation changes: different points of the wire undergo the magnetization process at different moments of time. As a result, the wire response pulse has a larger width and smaller amplitude, as compared to those of the strict alignment between the wire and force lines B₁. This results in an overlap between the responses produced by locally adjacent wires. If the biasing field gradient (e.g., DC magnetic field gradient), which has a constant value along the wire axis, is applied to the wire, all points of the wire are subjected to this biasing, which will produce a time shift of the wire response to the interrogating field. Accordingly, the points of the wire, which later respond to the interrogating AC traveling field (wire part W′) due to the wire inclination, will be subjected to the positive biasing field (+H_{b}) and their response will pass ahead. Similarly, the points of wire, which respond earlier (wire part W″), will be subjected to the negative biasing field (−H_{b}), and their response will be delayed. The preferred value of the magnetic gradient (i.e., the optimal compensation for the wire inclination) should be such that for each point of the wire a shift of the wire response to the interrogating traveling field due to the biasing field is equal and opposite in direction to the shift of the wire response caused by the phase distribution of the interrogating traveling field.

FIGS. 3C and 3D show a response of the tag oriented at 10 degrees relative to the force lines B₁ of the interrogating traveling field, for two cases, respectively: when subjected to the interrogating traveling field component only (i.e., without compensation) and when subjected to both interrogating traveling field component and the biasing gradient field component (with compensation). As shown, the application of the biasing gradient field component significantly improves the response signal of the inclined tag and thus facilitates the code reading.

As indicated above, the value of the magnetic field gradient that affects the wire response depends on the angle between the wire and the force lines of the interrogating traveling magnetic field. So, in the case when the angular orientation of the tag is known, the magnetic field gradient is selected such that for each point of the wire a shift of wire response to interrogating field component due to the biasing field is equal and opposite in direction to the shift of response caused by the phase distribution of the interrogating field component. In the case when the angular orientation of the tag is unknown, the value of the magnetic gradient is slowly swept to satisfy the compensation condition.

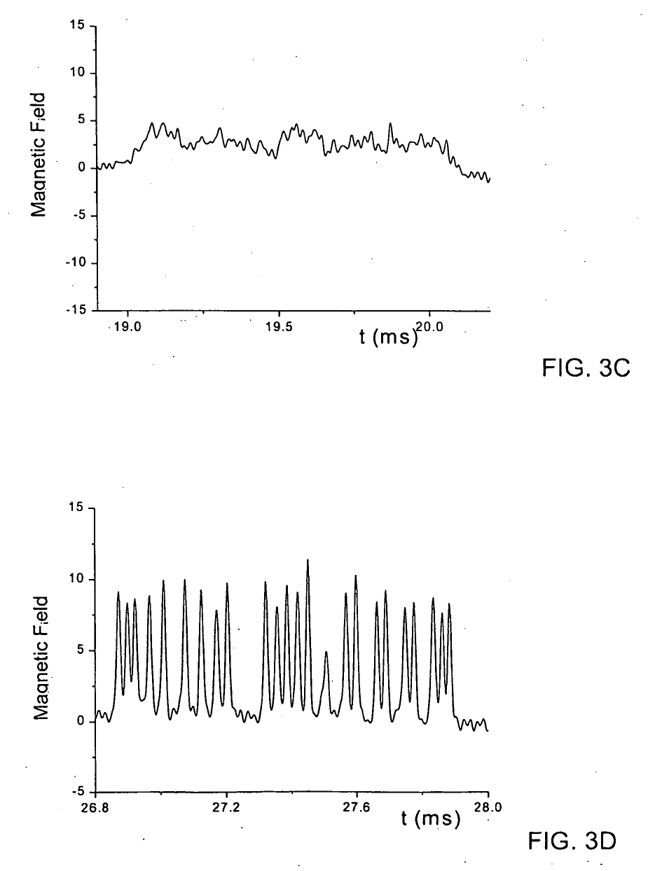

Reference is made to FIG. 4 schematically illustrating a tag reading system 100 of the present invention. The system includes a magnetic field source assembly 102 which is associated with an electronic device 104 and is operable to create a required magnetic field within an interrogating zone to thereby cause the tag response generation when the tag is located in the interrogating zone; a receiving unit 106 for receiving the response signal and generating data indicative thereof; and a control unit 108 connectable to the receiving unit 106 and operable to process and analyze the data indicative of the response signal to thereby retrieve information secured in the tag. The same control unit or another control utility operates the magnetic field source assembly.

The magnetic field source assembly 102 is configured to generate an interrogating AC traveling magnetic field component, with or without a biasing gradient field component compensating for a possible tag tilting. The AC traveling magnetic field component can be generated by at least two coils appropriately operated by electronic device 104 to provide a desired relation between electric current through the coils, as described further below. To implement the compensating component, either the same AC traveling magnetic field source (coils) may be used or an additional magnetic field source generating a sweeping gradient magnetic field component.

Generally, the interrogating AC traveling magnetic field component is created by at least two coils with a certain phase shift between electric currents in the coils. The electronic device 104 is configured and operable to provide the desired shift between the electric currents through the coils. The same electronic device or another suitable electronic utility is used to affect amplification and filtration of the output signal of the receiving unit, which is to be processed and analyzed. The control unit controls the interrogating means (magnetic field source) and the receiving unit, analysis the tag response signal and retrieves information secured in the tag.

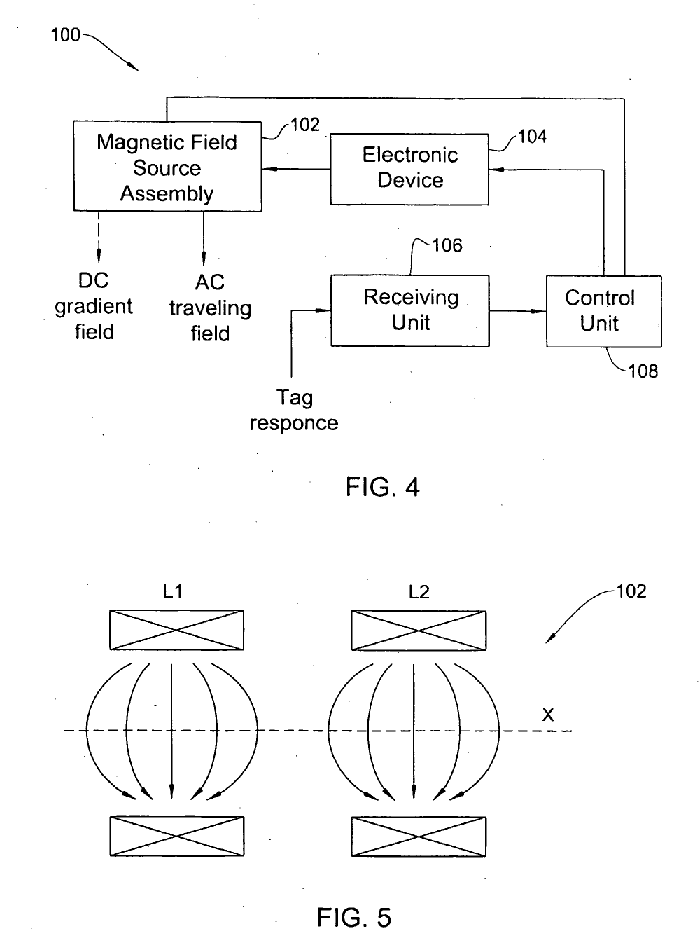

FIG. 5 illustrates an example of the magnetic field source assembly 102 for generating an AC traveling magnetic field component with or without the biasing gradient field component. In this example, the magnetic field source 102 includes two pairs of coils L₁ and L₂ arranged in a spaced-apart relationship along a line A. The coils are operable (by electronic device 104 in FIG. 4) to provide an electric current in one of the coils shifted at 90 degrees relative to the electric current in the other coil. Hence, electric currents I₁ and I₂ through the coils, respectively, are defined as Sin(wt) and Cos(wt), w being the magnetic field frequency and t being the time, and magnetic fields H₁(x) and H₂(x) created by the coils are defined as:

H₁(x)˜H_{m·F}(x−x₁)·Sin(wt)

H₂(x)˜H_{m·F}(x−x₂)·Cos(wt)

wherein Hₘ is the amplitude of the magnetic field, F(x) is a function describing a drop of the magnetic field with an increase of a distance between point x and a source of the magnetic field (i.e., respective one of the coils); x₁ and x₂ are positions of coils L₁ and L₂, respectively; and w is the magnetic field frequency.

The magnetic field created by source 102 in every point along the line A may be expressed as a superposition of the magnetic fields H₁(x) and H₂(x), and thus the magnetic field H(x,t) in point x at time t is determined as follows:

H(x,t)=Hₘ·F(x−x₁)·Sin(2·π·w·t)+Hₘ·F(x−x₂)·Cos(2·π·w·t) (1)

Evaluation of this equation provides the phase of the interrogating magnetic field as a function of coordinate x:

$$H ( x , t ) = {H}_{m} \cdot \sqrt{\begin{matrix}{( F ( x - {x}_{1} ) )}^{2} + \\ {( F ( x - {x}_{2} ) )}^{2}\end{matrix}} \cdot Sin ( 2 π \cdot w + arctan ( \frac{F ( x - {x}_{1} )}{F ( x - {x}_{2} )} ) )$$

wherein the phase shift as a function of coordinate x is defined by the member of equation arctn((F(x−x₁)/F(x−x₂)).

As indicated above, in order to compensate for a possible inclination of the tag with respect to the force lines of the AC traveling magnetic field, the same magnetic field source generating this field may be used to produce the field-compensating component (biasing field). This is implemented by appropriately operating (by electronic device denoted 104 in FIG. 4) the electric current through the coils. Considering for example four coils (which may be four coils of the two pairs of coils in FIG. 5), the electric currents flowing through the coils is determined in accordance with the following equations:

I₁=Iₘ·Sin(wt)+I_{b}

I₂=Iₘ·Cos(wt)+I_{b}

I₃=Iₘ·Sin(wt)−I_{b}

I₄=Iₘ·Sin(wt)−I_{b} (2)

wherein Iₘ is the amplitude of the AC component of the electric current through the coil, and I_{b} is the biasing component of the electric current.

According to the above equations (2), a part of the electric current comprising AC components, Iₘ, creates a space phase shifted distribution of the interrogating field, while the biasing components, I_{b}, create a magnetic field gradient necessary to compensate for the tag inclination with respect to the force lines of the magnetic field.

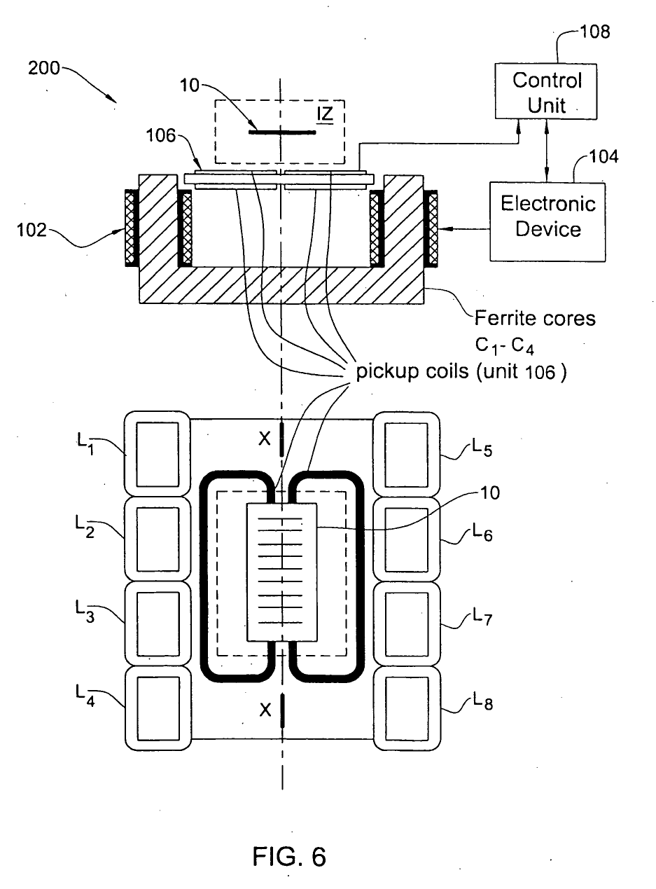

FIG. 6 exemplifies the implementation of a tag reading system 200 of the present invention. To facilitate understanding, the same reference numbers are used for identifying the components which are common in all the examples of the invention. The system 200 includes a magnetic field source assembly 102 associated with an electronic device 104; a receiving unit 106 for receiving a response signal from a tag 10 located in an interrogating zone IZ (i.e., the magnetic field region); and a control unit 108.

The magnetic field source assembly 102 is configured for generating, in the interrogating zone IZ, an AC traveling magnetic field components (AC field with a space phase shift distribution along an axis perpendicular to the force lines of this field component) and a sweeping biasing magnetic field component having a gradient directed along the force lines of the traveling field component. To this end, the magnetic field source 102 includes interrogating coils—eight such coils L₁-L₈ in the present example, wound on ferrite C-cores—four cores C₁-C₄ in the present example, and the electronic device operates to provide an appropriate phase shift between electric currents through the coils L₁-L₈, as described above.

The receiving unit 106 includes two pairs of receiving (pickup) coils S₁ and S₂ (i.e., four pick-up coils forming two coil pairs S₁ and S₂). A tag 10, when located in the interrogating zone IZ, responds to the interrogating field, and this response is received by the coil pairs S₁ and S₂ (i.e., affects the magnetic field generated by these coils). The coils of the pairs of coils S₁ and S₂ are connected such as to compensate a low frequency signal induced by the interrogating magnetic field (AC traveling field component). The position of the pairs of receiving coils S₁ and S₂ relative to the C-cores C₁-C₄ is chosen such as to minimize a spurious low frequency signal.

The phase shift between the electric currents I₁-I₈ flowing through the coils L₁-L₈, respectively, is set such as to create a nearly linear space phase distribution of the magnetic field, generated by these coils, along the X-axis (the magnetic force lines being directed along the Y-axis). This is achieved by providing the electric currents I₁-I₈ through the coils I₁-I₈ satisfying the following equations.

I₁=Iₘ·Sin(wt)+I_{b}

I₂=Iₘ·Cos(wt)+I_{b}

I₃=−Iₘ·Sin(wt)+−I_{b}

I₄=−Iₘ·Sin(wt)+I_{b}

I₅=Iₘ·Sin(wt)−I_{b}

I₆=Iₘ·Cos(wt)−I_{b}

I₇=−Iₘ·Sin(wt)−I_{b}

I₈=−Iₘ·Sin(wt)−I_{b} (3)

As seen from equations (3), AC current components through the adjacent coils are shifted at 90 degrees with respect to one another. In addition, electric currents passing through the coils I₁-I₈ have low frequency components (I_{b}) to create a sweeping bias gradient inside the interrogating zone IZ. As mentioned above, this gradient allows for compensating for the tag's angular orientation (inclination) relative to the force lines of the interrogating magnetic field.

For example, the amplitude of the electric current flowing through each coil is 35 mA. This current generates the interrogating AC traveling magnetic field component of 200 A/m amplitude at a distance of 10 mm above the receiving coils. The frequency of the interrogating field is 300 Hz. The compensation component of the electric current in each coil is about 10 mA. The frequency of compensation current is 40 Hz.

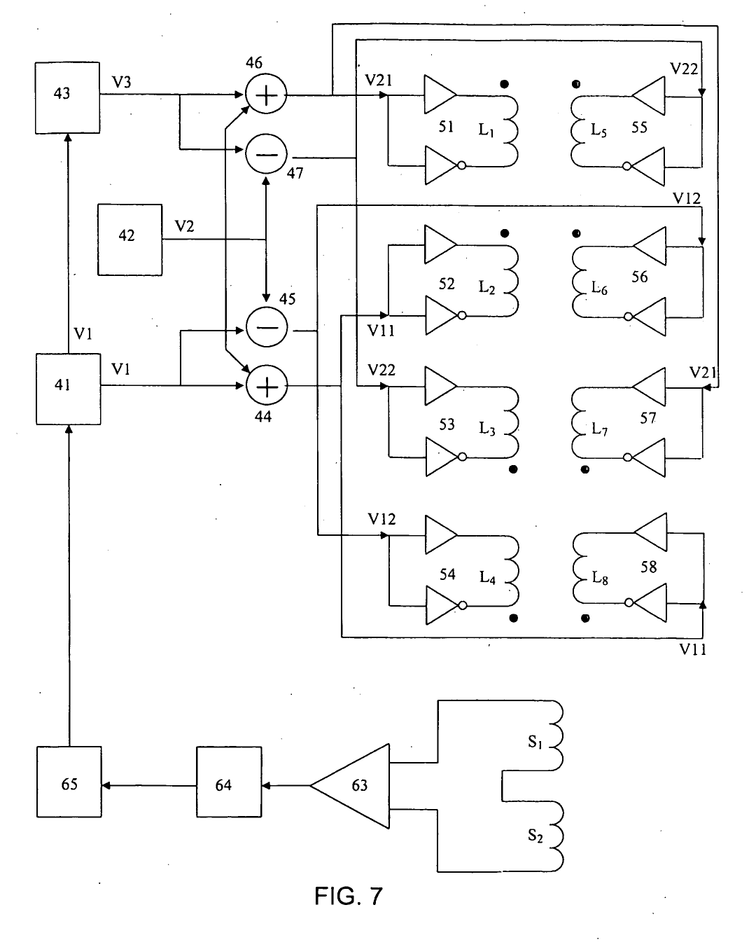

FIG. 7 exemplifies an electrical scheme of the system of the present invention. A first generator 41 creates a voltage signal, V₁, oscillating harmonically with a frequency f₁=300 Hz, which voltage signal is determined as.

V₁(t)=V₁₀·Sin(2·π·f₁·t)

wherein V₁₀ is the amplitude of the first signal.

A second generator 42 creates a voltage signal, V₂, oscillating harmonically with a frequency f₂=40 Hz, and determined as:

V₂(t)=V₂₀·Sin(2·π·f₂·t)

wherein V₂₀ is the amplitude of the second signal.

The signal V₁ from the first generator 41 passes through a phase shifter 43. An output signal, V₃, of the shifter 43 is 90 degrees shifted relative to the output signal V₁ of the generator 41, namely:

V₃(t)=V₁₀·Cos(2·π·f₁·t)

The signal, V₁, from the first generator 41 inputs a summation unit 44 and a subtraction unit 45. The signal, V₂, from the second generator 42 enters other input ports of units 44 and 45. Hence, an output signal, V₁₁, of the summation unit 44 is equal to:

V₁₁(t)=V₁₀·Sin(2·π·f₁·t)+V₂₀·Sin(2·πf₂·t)

Consequently, an output signal, V₁₂, of the subtraction unit 45 is equal to:

V₁₂(t)=V₁₀·Sin(2·π·f₁·t)−V₂₀·Sin(2·πf₂·t)

The signal, V₃, from the shifter 43 inputs a summation unit 46 and a subtraction unit 47. The signal, V₂, from the second generator 42 also inputs these units (via other input ports thereof). An output signal, V₂₁, of the summation unit 46 is equal to:

V₂₁(t)=V₁₀·Cos(2·π·f₁·t)+V₂₀·Sin(2·πf₂·t)

An output signal of the subtraction unit 47 is equal to:

V₂₂(t)=V₁₀·Cos(2·π·f₁·t)+V₂₀·Sin(2·πf₂·t)

The voltage signals V₁₁, V₁₂, V₂₁, V₂₂ passes current drivers 51-58, which drive currents through the coils L₁-L₈, respectively. The coils L₁-L₈ create magnetic fields H₁—H₈, respectively, determined as follows.

H₁(t)=A·Sin(2·π·f₁·t+B·Sin(2·πf₂·t)

H₂(t)=A·Cos(2·π·f₁·t+B·Sin(2·πf₂·t)

H₃(t)=−A·Sin(2·π·f₁·t+B·Sin(2·πf₂·t)

H₄(t)=−A·Cos(2·π·f₁·t+B·Sin(2·πf₂·t)

H₅(t)=A·Sin(2·π·f₁·t−B·Sin(2·πf₂·t)

H₆(t)=A·Cos(2·π·f₁·t−B·Sin(2·πf₂·t)

H₇(t)=−A·Sin(2·π·f₁·t−B·Sin(2·πf₂·t)

H₈(t)=−A·Sin(2·π·f₁·t−B·Sin(2·πf₂·t)

wherein A and B are the coefficients, determined by coils construction.

Superposition of the magnetic fields H₁—H₈ provides the interrogating magnetic field with a space phase distribution enabling identification of the response pattern and a bias magnetic gradient compensating for the possible tag inclination with respect to the force lines of the AC traveling field component.

A tag placed inside the interrogating zone responds to the interrogating magnetic field by a series of electromagnetic pulses. The time positions of these pulses are in strict correspondence with the space positions of wires of the tag.

The wires' response is detected by the pairs of receiving coils S₁ and S₂, and then signals from the receiving coils are amplified by an amplifier 63 and converted by an analog-to-digital converter 64 into the digital representation thereof. The so-obtained digitized response of the tag is received by a central processor unit 65 (control unit 108 in FIG. 6) where information secured in the tag is retrieved.

As indicated above, the code pattern carried by the tag is in the form of an array of magnetic elements arranged in accordance with the coded information, i.e., typically defined by spaces between the magnetic elements. Generally, the magnetic elements can be initially unequally spaced from one another in accordance with a predetermined code. However, this complicates the tag manufacturing process.

The present invention solves the above problem by arranging magnetic elements with equal spaces between them, and then “defecting” some (one or more) or the magnetic elements so as to be unreadable. By this, non-defective (readable) magnetic elements become unequally spaced from each other in accordance with predetermined coded information.

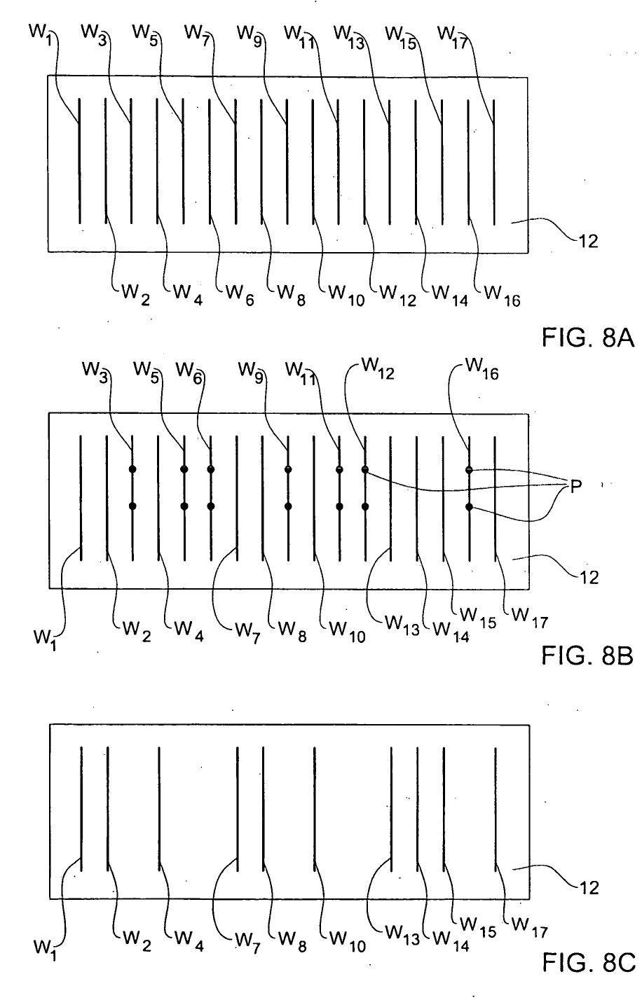

FIGS. 8A-8C illustrate the main principles of the present invention for manufacturing a magnetic tag. As shown in FIG. 8A, an array of elongated magnetic elements—seventeen such elements W₁-W₆ in the present example, are first arranged on a substrate 12 in a substantially equally spaced parallel relationship. Then, as shown in FIG. 8B, some of the magnetic elements (elements W₃, W₅, W₆, W₉, W₁₁, W₁₂ and W₁₆) are defected, while the other elements remain unchanged. The wires can be defected by applying thereto electromagnetic radiation (laser radiation) to form in each of these wires at least one hole P, e.g., removing the wire material from at least one location along the wire. For example, a pulse laser diode may be used, e.g., with a pulse energy of about 1J and a pulse duration of about 1 microsecond. The applied laser radiation evaporates the wire material, and such a perforated or broken magnetic element practically provides no response to an interrogating magnetic field. As a result, the defected (perforated/broken) magnetic element is undetectable and is thus recognizable by a tag reading system as a free space between non-defected (“active”) magnetic elements. FIG. 8C shows the “virtual” tag (resulted from the above process) as “seen” by a reading system. As shown, the perforated/broken wires are “seen” as a free space between the non-perforated wires.

The above technique simplifies the process of fabricating a tag carrying coded information. It should be understood that any other means may be used for “defecting” selective magnetic elements.

Thus, the present invention provides a system and method for reading a tag formed by an array of elongated magnetic elements arranged in accordance with certain coded information. The reading is implemented by applying to the tag an interrogating AC traveling magnetic field with the force lines directed substantially long the longitudinal axis of the magnetic element and phase shift distribution along an axis perpendicular to the force lines direction. Preferably, the magnetic field applied to the tag also includes a low-frequency field component with a gradient directed along the force lines of the AC traveling field component. Additionally, the present invention provides a novel magnetic tag configuration and a method for manufacturing such a tag.

Those skilled in the art will readily appreciate that various modifications and changes can be applied to the embodiments of the invention as hereinbefore exemplified without departing from its scope defined in and by the appended claims. For example, the interrogating field, which is an AC traveling magnetic field may and may not include a low-frequency (e.g., DC) gradient field component. The latter may be produced using a separate magnetic field source or by the same magnetic field source generating the AC traveling magnetic field. Interrogating the entire tag by the AC traveling magnetic field provides for producing the tag response pattern indicative of the magnetic elements' arrangement in the tag and thus indicative of the coded information secured in the tag. The provision of the DC gradient magnetic field component provides for compensating a possible inclination of the magnetic elements with respect to the force lines of the AC traveling field component.

1. A method of reading a magnetic tag, which is formed by an array of elongated magnetic elements arranged in a spaced-apart parallel relationship in accordance with a pattern of coded information, the method comprising applying to the tag an interrogating field, which has an alternating traveling magnetic field component with a space phase shift distribution along an axis perpendicular to a direction of force lines of the alternating traveling magnetic field component.

2. The method of claim 1, wherein the application of the alternating traveling magnetic field component to the tag provides a time shift of waveforms of the magnetic field component, thereby causing sequential interrogation of the successive magnetic elements, a pattern formed by response signals of all the magnetic elements to said alternating traveling magnetic field component thereby repeating the pattern of the magnetic elements and allowing for retrieving the information in the tag.

3. The method of claim 1, wherein said alternating traveling magnetic field component is applied to the tag such that the field force lines are directed substantially along the longitudinal axis of the elongated magnetic element.

4. The method of claim 1, wherein said magnetic field comprises a low-frequency gradient magnetic field component, with the field gradient being directed along the force lines of said alternating traveling field component.

5. The method of claim 4, wherein a value of the magnetic field gradient is selected to satisfy a certain condition to compensate for an angular orientation of the longitudinal axes of the magnetic elements with respect to the force lines of said alternating traveling magnetic field component.

6. The method of claim 5, wherein the value of the magnetic field gradient satisfying the compensation condition is such that, for each point of the magnetic element, the gradient field component effects a shift of the response of said point to the alternating traveling field component which is equal and opposite in direction to a shift of the response caused by the phase distribution of the alternating traveling magnetic field component.

7. The method of claim 4, wherein a value of the magnetic field gradient is such that, for each point of the magnetic element, the gradient field component effects a shift of the response thereof to the alternating traveling field component which is equal and opposite in direction to a shift of the response caused by the phase distribution of the alternating traveling magnetic field component.

8. The method of claim 7, wherein the gradient magnetic field component compensates for an angular orientation of the magnetic elements with respect to the force lines of said alternating traveling magnetic field component.

9. The method of claim 8, wherein the gradient magnetic field component is proportional to an angle of tag inclination with respect to the force lines of said alternating traveling magnetic field component.

10. The method of claim 6, comprising sweeping the magnetic field gradient to thereby obtain the value thereof satisfying the compensation condition.

11. The method of claim 8, comprising sweeping the magnetic field gradient to thereby obtain the value thereof satisfying the compensation condition.

12. The method of claim 1, wherein the alternating traveling magnetic field component is produced by at least two coils operable to provide a phase sift between electric currents trough said at least two coils.

13. The method of claim 4, wherein the alternating traveling magnetic field component and the gradient bias magnetic field component are produced by appropriately operating electric currents through at least two coil pairs.

14. The method of claim 13, wherein the electric currents through said at least two coil pairs are phase sifted with respect to each other.

15. The method of claim 14, wherein the electric current through each coil has an alternating component that creates the space phase shifted distribution of the magnetic field created by said coil, and a biasing component that creates the magnetic field gradient.

16. The method of claim 15, wherein the electric currents, 14-14, through four coils, respectively, are:
I₁=Iₘ·Sin(wt)+I_{b}
I₂=Iₘ·Cos(wt)+I_{b}
I₃=Iₘ·Sin(wt)−I_{b}
I₄=Iₘ·Sin(wt)−I_{b}
wherein Iₘ is the amplitude of the AC component of the electric current through the coil, and I_{b} is the biasing component of the electric current.

17. A system for use in reading a magnetic tag formed by at least one elongated magnetic element, the system comprising:
a magnetic field source assembly configured and operable to produce an interrogating field, which has an alternating traveling magnetic field component with a space phase shift distribution along an axis perpendicular to a direction of force lines of the alternating traveling magnetic field component;
a receiving unit for receiving a response signal pattern coming from the tag and generating data indicative thereof, thereby allowing for retrieving coded information in the tag.

18. The system of claim 17, wherein the magnetic field source assembly is configured and operable to produce a low frequency gradient magnetic field component with the magnetic field gradient being directed along a direction of force lines of said alternating traveling magnetic field component.

19. The system of claim 17, wherein the magnetic field source assembly is configured and operable to produce a DC gradient magnetic field component with the magnetic field gradient being directed along a direction of force lines of said alternating traveling magnetic field component.

20. The system of claim 17, wherein the magnetic field source assembly comprises at least two coils and an electronic device operating electric currents through said at least two coils to provide a phase shift between said electric currents.

21. The system of claim 20, wherein said electronic device operates the electric current through the coils to provide the electric current through each of the coils having an AC component that creates the space phase shifted distribution of the magnetic field created by said coil, and a biasing component that creates a DC magnetic field gradient directed along a direction of force lines of said alternating traveling magnetic field component.

22. The system of claim 17,
wherein the magnetic field source assembly has one of the following configurations:
(a) is configured and operable to produce a low frequency gradient magnetic field component with the magnetic field gradient being directed along a direction of force lines of said alternating traveling magnetic field component;
(b) is configured and operable to produce a DC gradient magnetic field component with the magnetic field gradient being directed along a direction of force lines of said alternating traveling magnetic field component
(c) comprises at least two coils, and an electronic device operating electric currents through said at least two coils to provide the electric current through each of the coils having an AC component that creates a space phase shifted distribution of the magnetic field created by said coil, and a biasing component that creates a DC magnetic field gradient directed along a direction of force lines of said alternating traveling magnetic field component;
wherein the value of the magnetic field gradient is such that, for each point of the magnetic element of the tag, the biasing gradient field component effects a shift of the response thereof to the alternating traveling field component which is equal and opposite in direction to a shift of the response caused by the phase distribution of the alternating traveling magnetic field component.

23. The system of claim 22, wherein the gradient magnetic field component compensates for an angular orientation of the magnetic element with respect to the force lines of said alternating traveling magnetic field.

24. The system of claim 23, wherein the magnetic field gradient is swept to thereby obtain the value thereof satisfying the compensation condition.

25. A magnetic tag carrying coded information, the tag comprising an array of magnetic elements arranged in a spaced-apart parallel relationship being substantially equally spaced from one another, one or more of said magnetic elements, selected in accordance with the coded information, having defects so as to be undetectable by a tag reading system, the defected magnetic element being thereby recognizable by the tag reading system as a free space between non-defected magnetic elements.

26. The tag of claim 25, wherein the defect has one of the following configurations: is a perforation made in the magnetic element; and is a region in the magnetic element where the magnetic material is at least partially removed.

27. A method for manufacturing a magnetic tag carrying coded information, the method comprising: (i) arranging multiple magnetic elements in a spaced-apart parallel relationship with substantially equal spaces between them, and (i) defecting one or more of said magnetic elements, selected in accordance with the coded information, so as to make the selected magnetic elements undetectable by a tag reading system, the defected magnetic element being thereby presenting, for a tag reading process, a free space between non-defected magnetic elements.

28. The method of claim 27, wherein the defecting comprises carrying out at least one of the following: (a) forming at least one perforation in the magnetic element; and (b) at least partially removing a magnetic material within at least one region of the magnetic element.

29. The method of claim 28, wherein the defecting comprises applying electromagnetic radiation to at least one selected location of the tag.
